(19) United States
(12) Patent Application Publication
(10) Pub. No.: US 2012/0290409 A1
(43) Pub. Date: Nov. 15, 2012

(54) MARKETING MATERIAL ENHANCED WAIT STATES

(75) Inventors: Anantha Pradeep, Berkeley, CA (US); Robert T. Knight, Berkeley, CA (US); Ramachandran Gurumoorthy, Berkeley, CA (US)

(73) Assignee: NEUROFOCUS, INC., Berkeley, CA (US)

(21) Appl. No.: 13/105,774

(22) Filed: May 11, 2011

(51) Int. Cl. G06Q 30/00

(52) U.S. Cl. 705/14.73

(57) ABSTRACT

A marketing materials presentation system identifies wait states such as loading states and idle states and selects marketing materials for presentation during wait states. Marketing materials may be selected based on materials viewed prior to a wait state and activity requested that triggered the wait state. In some examples, characteristics of a viewer including demographic informational, profile data, past viewing and purchase activity, neuro-response data, etc., is analyzed to select wait state marketing materials. Wait state marketing materials may also be selected using wait state characteirstics and marketing material characteristics.

### TECHNICAL FIELD

The present disclosure relates to a marketing material enhanced wait states.

### DESCRIPTION OF RELATED ART

Conventional systems for selection and presentation of marketing materials such as advertisements are limited. Some conventional systems allow selection of advertisements for presentation during particular time slots. Analysis conducted to place advertising may involve evaluation of demographic information and statistical data. However, conventional systems are subject to inefficiencies, as marketing materials providers can not effectively determine the most efficient mechanisms for presenting their materials and advertisements.

Consequently, it is desirable to provide improved methods and apparatus for selection and presentation of marketing materials from various sources.

### BRIEF DESCRIPTION OF THE DRAWINGS

The disclosure may best be understood by reference to the following description taken in conjunction with the accompanying drawings, which illustrate particular example embodiments.

FIG. 1A illustrates one example of a system for implementing a multimedia wait state marketing material presentation system.

FIG. 1B illustrates an example of a system for obtaining advertisement characteristics.

FIG. 2 illustrates examples of stimulus attributes that can be included in a repository.

FIG. 3 illustrates examples of data models that can be used with a stimulus and response repository.

FIG. 4 illustrates one example of a query that can be used with the wait state marketing material presentation system.

FIG. 5 illustrates one example of a report generated using the wait state marketing material presentation system.

FIG. 6 illustrates one example of technique for wait state marketing material presentation system implementation.

FIG. 7 provides one example of a system that can be used to implement one or more mechanisms.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of marketing materials for particular platforms. However, it should be noted that some of the techniques and mechanisms can be applied to a variety of platforms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

A marketing materials presentation system identifies wait states such as loading states and idle states and selects marketing materials for presentation during wait states. Marketing materials may be selected based on materials viewed prior to a wait state and activity requested that triggered the wait state. In some examples, characteristics of a viewer including demographic informational, profile data, past viewing and purchase activity, neuro-response data, etc., is analyzed to select wait state marketing materials. Wait state marketing materials may also be selected using wait state characteirstics and marketing material characteristics.

### Example Embodiments

Conventional mechanisms for presenting marketing materials are limited. One problem with conventional mechanisms for managing materials is that they do not allow efficient selection and presentation of marketing materials in an unobstrusive manner. For example, to present particular marketing materials, an software company may be able to select and buy advertisement slots based on programming demographic, but the software company does not have efficient access to information such as survey based priming and retention characteristics for software company advertisements. The software company also may not fully appreciate the type of advertisement slot to purchase as there are varying characteristics for different media such as print, video, audio, banner, etc. Conventional mechanisms may allow for limited experience based selection of marketing materials for various products, services, and offerings.

In these respects, a system for wait state presentation of marketing materials provides additional mechanisms for selecting and presenting marketing materials such as advertisements and offers in an efficient and effective manner. According to various embodiments, it is recognized that marketing materials for particular products, services, and offerings may be particularly effective when a user is primed for the particular products, services, and offerings by other related content in close proximity to the subject commercial or advertisements. For example, marketing materials for cleaning supplies may be particularly effective for viewers who have viewed a news piece on a particular illness and may be waiting for a video or application to load. Marketing materials for a yacht may be particularly effective for viewers who have recently experience content relating to sailing and may be waiting for some materials to download or print. In still other examples, an audio advertisement for visiting a forein country may be more effective while waiting for a piece of foreign music to buffer in an audio player or after listening to show on traveling.

It is also recognized that user attention, engagement, and retention levels at various points in a wait state may vary. The techniques and mechanisms of the present invention allow marketing material presentation to account for different wait states and different points in a wait state.

For example, it may be determined that initially in a wait state, a viewer has high attention and engagement levels but medium retention levels based on survey and demographic data. Advertisers and other companies may intelligently select marketing materials for presentation during particular wait states, types of wait states, or at particular points in various wait states.

The techniques and mechanisms of the present invention provide more individualized selection and presentation for marketing materials in various wait states, such as states when an application is being launched, data is being downloaded, material is being uploaded, documents are being printed, etc.

Consequently, the techniques and mechanisms of the present invention determine characteristics of wait states, marketing materials, and/or viewers. According to various embodiments, characteristics are determined using surveys, focus groups, and/or neuro-response data such as electroencephalography (EEG) data evauating characteristics such as priming, attention, engagement, and retention. These characteristics can be used to automatically match wait states, marketing materials, and viewers. In some examples, wait states are automaticall identified and marketing materials are presented to particular viewers during automatically identified wait states.

According to various embodiments, the techniques and mechanisms of the present invention may use a variety of mechanisms such as survey based responses, statistical data, and demographic data to improve wait state management. Data analysis and synthesis of different types of data allow generation of a composite output characterizing the significance of various data responses to effectively characterize wait states for marketing material presentation.

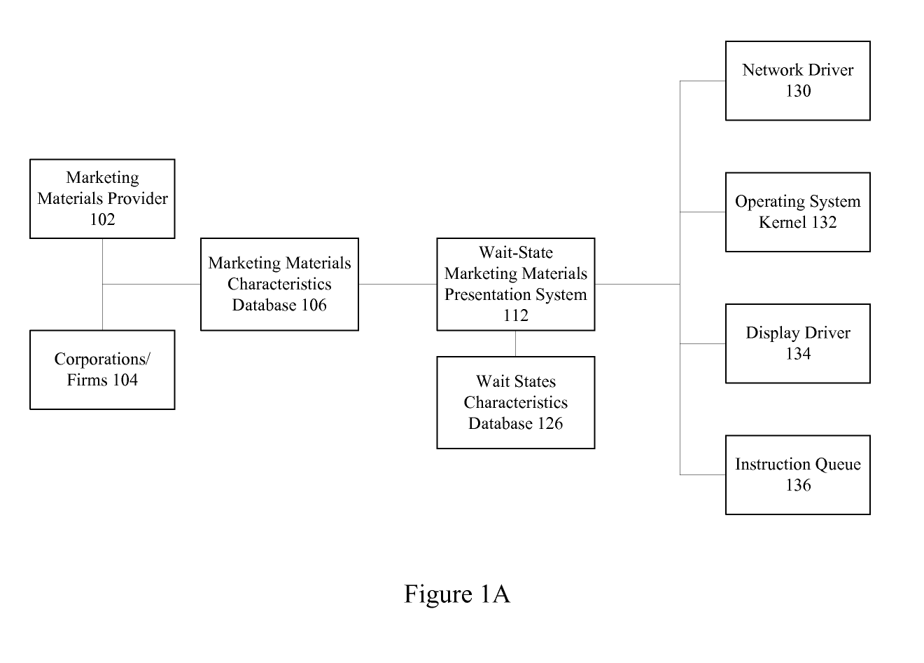

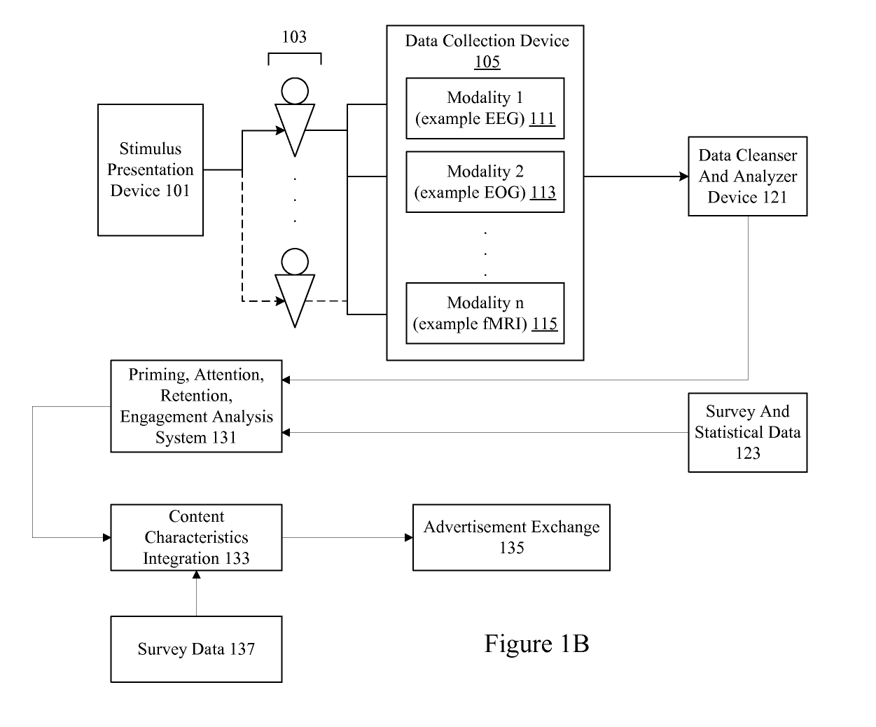

FIG. 1A illustrates one example of a wait state marketing material presentation system. A wait state marketing material presentation system 112 can use a variety of mechanisms for identifying wait states. In some examples, a wait state marketing material presentation system 112 is integrated with an application that anticipates wait states and requests marketing materials for presentation during these wait states. The application may be a browser application that determines that a large data file is about to be downloaded, creating a potential wait state. Wait state marketing material presentation system 112 integration with an application allows for clear determination of wait state periods.

In other examples, a wait state marketing material presentation system 112 automatically determines wait states even without application integration. In some examples, the wait state marketing materials presentation system 112 monitors a network driver 130 to determine that a large amount of data is being transmitted or received. While waiting for a data transmission to complete, the wait state marketing materials presentation system 122 may introduce marketing materials maintained locally. The wait state marketing materials presentation system 122 may also monitor an operating system kernel 132 to determine idle periods. A display driver 134 and a processor instruction queue 136 may also be monitored. In some examples, a display driver 134 may give indications that a status bar is running and an action may not complete for a determinable period of time. A processor instruction queue 136 may indicate that a processor is idle or is waiting for an operating on another device or component to complete. Monitoring various components and modules can provide a wait state marketing materials presentation system 112 with information on when wait states are available. Monitoring wait states associated with a platform environment including monitoring display drivers, operating system kernels, network queues, etc. is referred to herein at platform monitoring. Platform monitoring is not merely a module within an application that detects wait states associated with the same application. Platform monitoring can detect wait states associated with a variety of applications, operating systems, functional components, hardware components, etc.

Wait states characteristics may be maintained in a database 126. In some examples, a wait state marketing materials presentation system 122 determines characteristics of a wait state such as duration, type of content occuring before and/or after the wait state, substance of content before and/or after wait state, amount of processor resources available, etc. The wait state characteristics can inform selection of marketing materials for introduction during corresponding wait states.

In particular embodiments, a marketing materials characteristics database 106 is also associated with a wait state marketing material presentation system 112. The marketing materials characteristics database 106 may be preloaded with marketing materials such as advertisements that marketing material providers 102 and corporations/firms 104 provide to the wait state marketing material presentation system 112. The wait state marketing material presentation system may place marketing materials in wait states based on characteristics of the marketing materials. According to various embodiments, the marketing materials characteristics database 106 may indicate that a particular commercial could best be placed in a slot with a high priming metric for food. Advertisers may provide marketing materials to a wait state marketing material presentation system 112 to automatically place the marketing materials in slots that meet criteria such as target audience exposure levels and retention metrics in a cost effective manner.

It should be noted that although the wait state marketing material presentation system is described as using survey based, statistical, and demographic data, other types of data can be used to enhance a wait state marketing material presentation system. In some examples, neuro-response data is used to enhance advertisement as well as advertisement slot evaluation.

According to various embodiments, a wait state period neuro-response database is also associated with the wait state marketing material presentation system 112. The advertisement slot neuro-response database may be integrated with the advertisement slot characteristics database 126 or maintained separately. The advertisement slot neuro-response database includes characteristics such as attention, priming, retention, and engagement levels for a particular wait state period. For example, priming levels for cleanser commercials during a documentary about infections may be high. Retention levels for a wait state period during a particular action sequence may be high. Neuro-response metrics are determined for various wait state periods. The neuro-response database provides marketing material providers with additional insight useful in assessing the value of particular wait state periods.

FIG. 1B illustrates one example of a data collection system for determining wait state period and marketing material characteristics in a wait state marketing material presentation system. The system may use only survey and statistical data 123. However, in some examples, the system may also use neuro-response data. The system includes a stimulus presentation device 101. According to various embodiments, the stimulus presentation device 101 is merely a display, monitor, screen, etc., that displays stimulus material to a user. The stimulus material may be a media clip, a commercial, pages of text, a brand image, a performance, a magazine advertisement, a movie, an audio presentation, an advertisement, a banner ad, commercial, and may even involve particular tastes, smells, textures and/or sounds. The stimuli can involve a variety of senses and occur with or without human supervision. Continuous and discrete modes are supported. According to various embodiments, the stimulus presentation device 101 also has protocol generation capability to allow intelligent customization of stimuli provided to multiple subjects in different markets.

According to various embodiments, stimulus presentation device 101 could include devices such as televisions, cable consoles, computers and monitors, projection systems, display devices, speakers, tactile surfaces, etc., for presenting the stimuli including but not limited to advertising and entertainment from different networks, local networks, cable channels, syndicated sources, websites, internet content aggregators, portals, service providers, etc.

According to various embodiments, the subjects 103 are connected to data collection devices 105. The data collection devices 105 may include a variety of neuro-response measurement mechanisms including neurological and neurophysiological measurements systems such as EEG, EOG, FMRI, EKG, pupillary dilation, eye tracking, facial emotion encoding, and reaction time devices, etc. According to various embodiments, neuro-response data includes central nervous system, autonomic nervous system, and effector data. In particular embodiments, the data collection devices 105 include EEG 111, EOG 113, and FMRI 115. In some instances, only a single data collection device is used. Data collection may proceed with or without human supervision.

The data collection device 105 collects neuro-response data from multiple sources. This includes a combination of devices such as central nervous system sources (EEG), autonomic nervous system sources (FMRI, EKG, pupillary dilation), and effector sources (EOG, eye tracking, facial emotion encoding, reaction time). In particular embodiments, data collected is digitally sampled and stored for later analysis. In particular embodiments, the data collected could be analyzed in real-time. According to particular embodiments, the digital sampling rates are adaptively chosen based on the neurophysiological and neurological data being measured.

In particular embodiments, the wait state marketing material presentation system includes EEG 111 measurements made using scalp level electrodes, EOG 113 measurements made using shielded electrodes to track eye data, FMRI 115 measurements performed using a differential measurement system, a facial muscular measurement through shielded electrodes placed at specific locations on the face, and a facial affect graphic and video analyzer adaptively derived for each individual.

In particular embodiments, the data collection devices are clock synchronized with a stimulus presentation device 101. In particular embodiments, the data collection devices 105 also include a condition evaluation subsystem that provides auto triggers, alerts and status monitoring and visualization components that continuously monitor the status of the subject, data being collected, and the data collection instruments. The condition evaluation subsystem may also present visual alerts and automatically trigger remedial actions. According to various embodiments, the data collection devices include mechanisms for not only monitoring subject neuro-response to stimulus materials, but also include mechanisms for identifying and monitoring the stimulus materials. For example, data collection devices 105 may be synchronized with a set-top box to monitor channel changes. In other examples, data collection devices 105 may be directionally synchronized to monitor when a subject is no longer paying attention to stimulus material. In still other examples, the data collection devices 105 may receive and store stimulus material generally being viewed by the subject, whether the stimulus is a program, a commercial, printed material, or a scene outside a window. The data collected allows analysis of neuro-response information and correlation of the information to actual stimulus material and not mere subject distractions.

According to various embodiments, the wait state marketing material presentation system also includes a data cleanser device 121. In particular embodiments, the data cleanser device 121 filters the collected data to remove noise, artifacts, and other irrelevant data using fixed and adaptive filtering, weighted averaging, advanced component extraction (like PCA, ICA), vector and component separation methods, etc. This device cleanses the data by removing both exogenous noise (where the source is outside the physiology of the subject, e.g. a phone ringing while a subject is viewing a video) and endogenous artifacts (where the source could be neurophysiological, e.g. muscle movements, eye blinks, etc.).

The artifact removal subsystem includes mechanisms to selectively isolate and review the response data and identify epochs with time domain and/or frequency domain attributes that correspond to artifacts such as line frequency, eye blinks, and muscle movements. The artifact removal subsystem then cleanses the artifacts by either omitting these epochs, or by replacing these epoch data with an estimate based on the other clean data (for example, an EEG nearest neighbor weighted averaging approach).

According to various embodiments, the data cleanser device 121 is implemented using hardware, firmware, and/or software. It should be noted that although a data cleanser device 121 is shown located after a data collection device 105 and before content characteristics integration 133, the data cleanser device 121 like other components may have a location and functionality that varies based on system implementation. For example, some systems may not use any automated data cleanser device whatsoever while in other systems, data cleanser devices may be integrated into individual data collection devices.

In particular embodiments, an optional survey and interview system collects and integrates user survey and interview responses to combine with neuro-response data to more effectively select content for delivery. According to various embodiments, the survey and interview system obtains information about user characteristics such as age, gender, income level, location, interests, buying preferences, hobbies, etc. The survey and interview system can also be used to obtain user responses about particular pieces of stimulus material.

According to various embodiments, the priming repository system 131 associates meta-tags with various temporal and spatial locations in program content and provides these meta-tags to an advertisement characteristics database associated with a wait state marketing material presentation system. In some examples, commercial or advertisement breaks are provided with a set of meta-tags that identify commercial or advertising content that would be most suitable for a particular advertisement slot. The slot may be a particular position in a commercial pod or a particular location on a page.

Each slot may identify categories of products and services that are primed at a particular point in a cluster. The content may also specify the level of priming associated with each category of product or service. For example, a first commercial may show an old house and buildings. Meta-tags may be manually or automatically generated to indicate that commercials for home improvement products would be suitable for a particular advertisement slot or slots following the first commercial.

In some instances, meta-tags may include spatial and temporal information indicating where and when particular advertisements should be placed. For example, a page that includes advertisements about pet adoptions may indicate that a banner advertisement for pet care related products may be suitable. The advertisements may be separate from a program or integrated into a program. According to various embodiments, the priming repository system 131 also identifies scenes eliciting significant audience resonance to particular products and services as well as the level and intensity of resonance. The information in the priming repository system 131 may be manually or automatically generated and may be associated with other characteristics such as retention, attention, and engagement characteristics. In some examples, the priming repository system 131 has data generated by determining resonance characteristics for temporal and spatial locations in various programs, games, commercial pods, pages, etc.

The information from a priming, attention, engagement, and retention repository system 131 may be combined along with type, demographic, time, and modality information using a content characteristics integration system 133. According to various embodiments, the content characteristics integration system weighs and combines components of priming, attention, engagement, retention, personalization, demographics, etc. to allow selection, purchase, and placement of advertising in effective advertisement slots. The material may be marketing, entertainment, informational, etc.

In particular embodiments, neuro-response preferences are blended with conscious, indicated, and/or inferred user preferences to select neurologically effective advertising for presentation to the user. In one particular example, neuro-response data may indicate that beverage advertisements would be suitable for a particular advertisement break. User preferences may indicate that a particular viewer prefers diet sodas. An advertisement for a low calorie beverage may be selected and provided to the particular user. According to various embodiments, a set of weights and functions use a combination of rule based and fuzzy logic based decision making to determine the areas of maximal overlap between the priming repository system and the personalization repository system. Clustering analysis may be performed to determine clustering of priming based preferences and personalization based preferences along a common normalized dimension, such as a subset or group of individuals. In particular embodiments, a set of weights and algorithms are used to map preferences in the personalization repository to identified maxima for priming.

According to various embodiments, the wait state marketing material presentation system includes a data analyzer associated with the data cleanser 121. The data analyzer uses a variety of mechanisms to analyze underlying data in the system to determine resonance. According to various embodiments, the data analyzer customizes and extracts the independent neurological and neuro-physiological parameters for each individual in each modality, and blends the estimates within a modality as well as across modalities to elicit an enhanced response to the presented stimulus material. In particular embodiments, the data analyzer aggregates the response measures across subjects in a dataset.

According to various embodiments, neurological and neuro-physiological signatures are measured using time domain analyses and frequency domain analyses. Such analyses use parameters that are common across individuals as well as parameters that are unique to each individual. The analyses could also include statistical parameter extraction and fuzzy logic based attribute estimation from both the time and frequency components of the synthesized response.

In some examples, statistical parameters used in a blended effectiveness estimate include evaluations of skew, peaks, first and second moments, distribution, as well as fuzzy estimates of attention, emotional engagement and memory retention responses.

According to various embodiments, the data analyzer may include an intra-modality response synthesizer and a cross-modality response synthesizer. In particular embodiments, the intra-modality response synthesizer is configured to customize and extract the independent neurological and neurophysiological parameters for each individual in each modality and blend the estimates within a modality analytically to elicit an enhanced response to the presented stimuli. In particular embodiments, the intra-modality response synthesizer also aggregates data from different subjects in a dataset.

According to various embodiments, the cross-modality response synthesizer or fusion device blends different intra-modality responses, including raw signals and signals output. The combination of signals enhances the measures of effectiveness within a modality. The cross-modality response fusion device can also aggregate data from different subjects in a dataset.

According to various embodiments, the data analyzer also includes a composite enhanced effectiveness estimator (CEEE) that combines the enhanced responses and estimates from each modality to provide a blended estimate of the effectiveness. In particular embodiments, blended estimates are provided for each exposure of a subject to stimulus materials. The blended estimates are evaluated over time to assess resonance characteristics. According to various embodiments, numerical values are assigned to each blended estimate. The numerical values may correspond to the intensity of neuro-response measurements, the significance of peaks, the change between peaks, etc. Higher numerical values may correspond to higher significance in neuro-response intensity. Lower numerical values may correspond to lower significance or even insignificant neuro-response activity. In other examples, multiple values are assigned to each blended estimate. In still other examples, blended estimates of neuro-response significance are graphically represented to show changes after repeated exposure.

According to various embodiments, a data analyzer passes data to a resonance estimator that assesses and extracts resonance patterns. In particular embodiments, the resonance estimator determines entity positions in various stimulus segments and matches position information with eye tracking paths while correlating saccades with neural assessments of attention, memory retention, and emotional engagement. In particular embodiments, the resonance estimator stores data in the priming repository system. As with a variety of the components in the system, various repositories can be co-located with the rest of the system and the user, or could be implemented in remote locations.

Data from various sources including survey based data 137 may be blended and passed to a wait state marketing material presentation system 135. In some examples, survey based data 137 and demographic data may be used without neuro-response data. According to various embodiments, the wait state marketing material presentation system 135 manages advertisements such as commercials and print banners and identifies slots having characteristics appropriate for the advertisements. Appropriateness may be based on advertisement type, neuro-response characteristics of advertisements, neuro-response characteristics of advertisement slots, demographic information, etc. Advertisement slots in a commercial pod may be offered to a variety of advertisers, companies, firms, and individuals. In some examples, advertisement slots may be auctioned using variety of bid mechanisms. Characteristics of a slot in a particular commercial pod may be modified as other slots in the pod are sold on a real-time basis. It is recognized that the programming as well as other advertisements surrounding a wait state period affect priming, attention, engagement, and retention characteristics of the advertisement slot.

Commercials in a pod may be ordered in a particular manner to optimize effectiveness. Advertisements on a page may be rearranged to improve viewer response. According to various embodiments, the wait state marketing material presentation system 135 receives bids, selects, and assembles in a real time, a near real time, or a time delayed manner advertisements for placement in advertisement slots by associating neuro-response characteristics of slots with characteristics of advertisements.

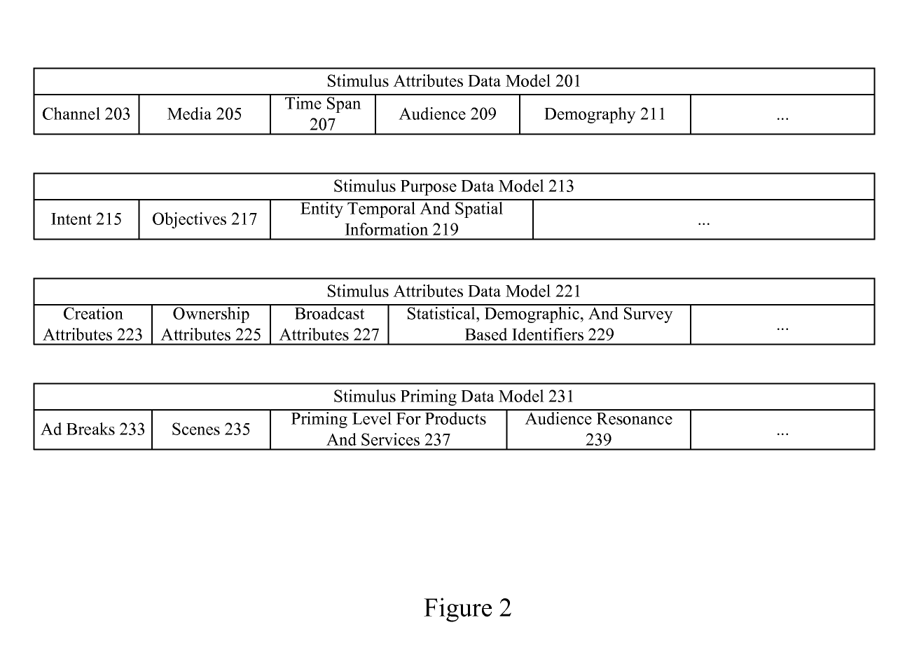

FIG. 2 illustrates examples of data models that may be used with a wait state marketing material presentation system. According to various embodiments, a stimulus attributes data model 201 includes a channel 203, media type 205, time span 207, audience 209, and demographic information 211. A stimulus purpose data model 213 may include intents 215 and objectives 217. According to various embodiments, stimulus purpose data model 213 also includes spatial and temporal information 219 about entities and emerging relationships between entities.

According to various embodiments, another stimulus attributes data model 221 includes creation attributes 223, ownership attributes 225, broadcast attributes 227, and statistical, demographic and/or survey based identifiers 229 for automatically integrating the neuro-physiological and neuro-behavioral response with other attributes and meta-information associated with the stimulus.

According to various embodiments, a stimulus priming data model 231 includes fields for identifying advertisement breaks 233 and scenes 235 that can be associated with various priming levels 237 and audience resonance measurements 239. In particular embodiments, the data model 231 provides temporal and spatial information for ads, scenes, events, locations, etc. that may be associated with priming levels and audience resonance measurements. In some examples, priming levels for a variety of products, services, offerings, etc. are correlated with temporal and spatial information in source material such as a movie, billboard, advertisement, commercial, store shelf, etc. In some examples, the data model associates with each second of a show a set of meta-tags for pre-break content indicating categories of products and services that are primed. The level of priming associated with each category of product or service at various insertions points may also be provided. Audience resonance measurements and maximal audience resonance measurements for various scenes and advertisement breaks may be maintained and correlated with sets of products, services, offerings, etc.

The priming and resonance information may be used to select advertisements suited for particular levels of priming and resonance corresponding to identified advertisement slots.

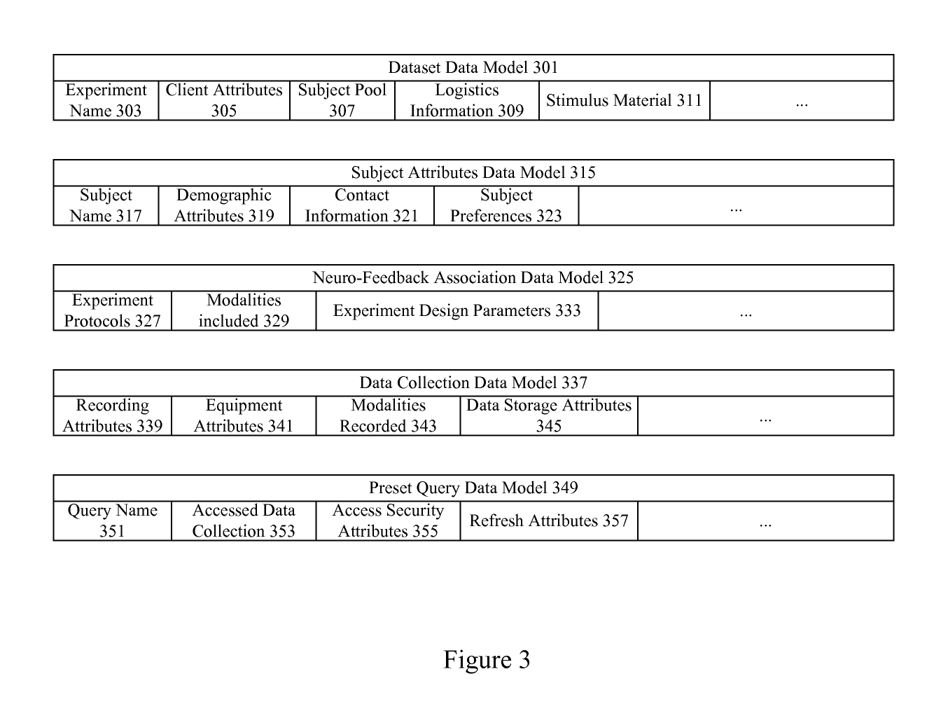

FIG. 3 illustrates examples of data models that can be used for storage of information associated with marketing material presentation during wait states. In particular embodiments, marketing materials presented during wait states can be evaluated to determine effectiveness. According to various embodiments, a dataset data model 301 includes an experiment name 303 and/or identifier, client attributes 305, a subject pool 307, logistics information 309 such as the location, date, and time of testing, and stimulus material 311 including stimulus material attributes.

In particular embodiments, a subject attribute data model 315 includes a subject name 317 and/or identifier, contact information 321, and demographic attributes 319 that may be useful for review of neurological and neuro-physiological data. Some examples of pertinent demographic attributes include marriage status, employment status, occupation, household income, household size and composition, ethnicity, geographic location, sex, race. Other fields that may be included in data model 315 include subject preferences 323 such as shopping preferences, entertainment preferences, and financial preferences. Shopping preferences include favorite stores, shopping frequency, categories shopped, favorite brands. Entertainment preferences include network/cable/satellite access capabilities, favorite shows, favorite genres, and favorite actors. Financial preferences include favorite insurance companies, preferred investment practices, banking preferences, and favorite online financial instruments. A variety of product and service attributes and preferences may also be included. A variety of subject attributes may be included in a subject attributes data model 315 and data models may be preset or custom generated to suit particular purposes.

According to various embodiments, data models for neuro-feedback association 325 identify experimental protocols 327, modalities included 329 such as EEG, EOG, FMRI, surveys conducted, and experiment design parameters 333 such as segments and segment attributes. Other fields may include experiment presentation scripts, segment length, segment details like stimulus material used, inter-subject variations, intra-subject variations, instructions, presentation order, survey questions used, etc. Other data models may include a data collection data model 337. According to various embodiments, the data collection data model 337 includes recording attributes 339 such as station and location identifiers, the data and time of recording, and operator details. In particular embodiments, equipment attributes 341 include an amplifier identifier and a sensor identifier.

Modalities recorded 343 may include modality specific attributes like EEG cap layout, active channels, sampling frequency, and filters used. EOG specific attributes include the number and type of sensors used, location of sensors applied, etc. Eye tracking specific attributes include the type of tracker used, data recording frequency, data being recorded, recording format, etc. According to various embodiments, data storage attributes 345 include file storage conventions (format, naming convention, dating convention), storage location, archival attributes, expiry attributes, etc.

A preset query data model 349 includes a query name 351 and/or identifier, an accessed data collection 353 such as data segments involved (models, databases/cubes, tables, etc.), access security attributes 355 included who has what type of access, and refresh attributes 357 such as the expiry of the query, refresh frequency, etc. Other fields such as push-pull preferences can also be included to identify an auto push reporting driver or a user driven report retrieval system.

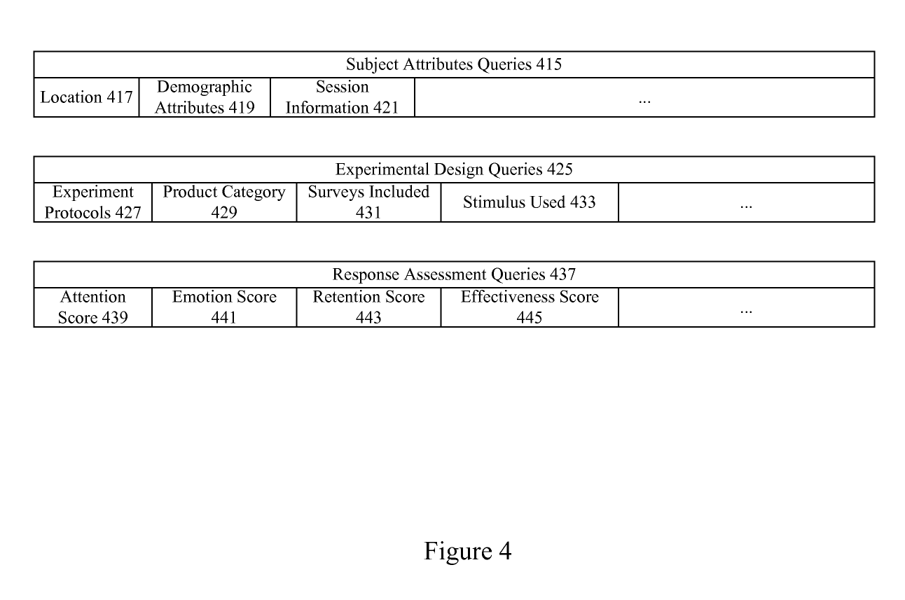

FIG. 4 illustrates examples of queries that can be performed to obtain data associated with a wait state marketing material presentation system. According to various embodiments, queries are defined from general or customized scripting languages and constructs, visual mechanisms, a library of preset queries, diagnostic querying including drill-down diagnostics, and eliciting what if scenarios. According to various embodiments, subject attributes queries 415 may be configured to obtain data from a neuro-informatics repository using a location 417 or geographic information, session information 421 such as testing times and dates, and demographic attributes 419. Demographics attributes include household income, household size and status, education level, age of kids, etc.

Other queries may retrieve stimulus material based on shopping preferences of subject participants, countenance, physiological assessment, completion status. For example, a user may query for data associated with product categories, products shopped, shops frequented, subject eye correction status, color blindness, subject state, signal strength of measured responses, alpha frequency band ringers, muscle movement assessments, segments completed, etc. Experimental design based queries 425 may obtain data from a neuro-informatics repository based on experiment protocols 427, product category 429, surveys included 431, and stimulus provided 433. Other fields that may be used include the number of protocol repetitions used, combination of protocols used, and usage configuration of surveys.

Client and industry based queries may obtain data based on the types of industries included in testing, specific categories tested, client companies involved, and brands being tested. Response assessment based queries 437 may include attention scores 439, emotion scores, 441, retention scores 443, and effectiveness scores 445. Such queries may obtain materials that elicited particular scores.

Response measure profile based queries may use mean measure thresholds, variance measures, number of peaks detected, etc. Group response queries may include group statistics like mean, variance, kurtosis, p-value, etc., group size, and outlier assessment measures. Still other queries may involve testing attributes like test location, time period, test repetition count, test station, and test operator fields. A variety of types and combinations of types of queries can be used to efficiently extract data.

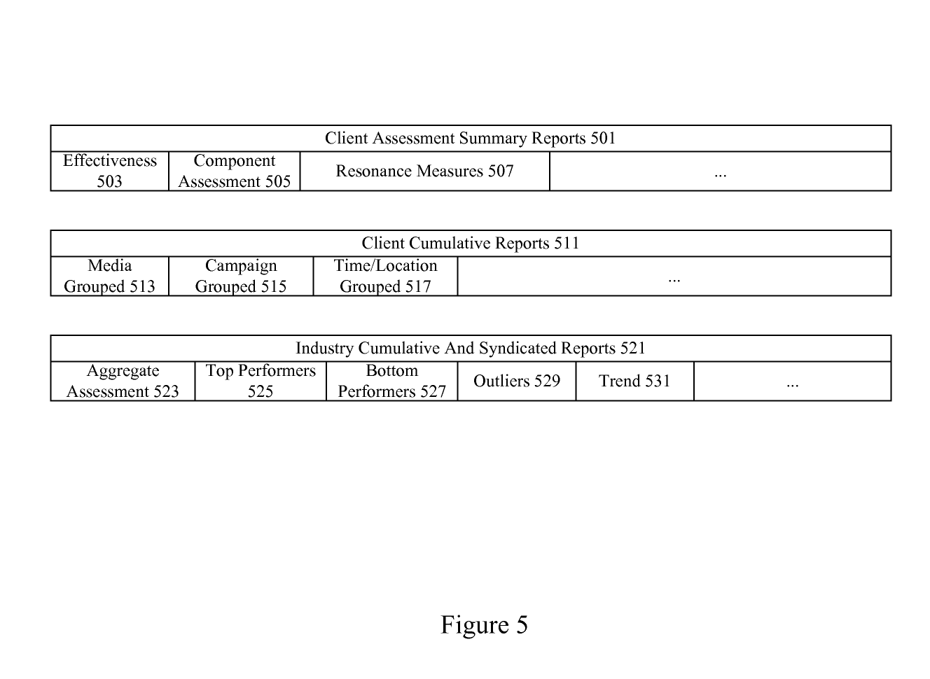

FIG. 5 illustrates examples of reports that can be generated. According to various embodiments, client assessment summary reports 501 include effectiveness measures 503, component assessment measures 505, and resonance measures 507. Effectiveness assessment measures include composite assessment measure(s), industry/category/client specific placement (percentile, ranking, etc.), actionable grouping assessment such as removing material, modifying segments, or fine tuning specific elements, etc, and the evolution of the effectiveness profile over time. In particular embodiments, component assessment reports include component assessment measures like attention, emotional scores, percentile placement, ranking, etc. Component profile measures include time based evolution of the component measures and profile statistical assessments. According to various embodiments, reports include the number of times material is assessed, attributes of the multiple presentations used, evolution of the response assessment measures over the multiple presentations, and usage recommendations.

According to various embodiments, client cumulative reports 511 include media grouped reporting 513 of all stimulus assessed, campaign grouped reporting 515 of stimulus assessed, and time/location grouped reporting 517 of stimulus assessed. According to various embodiments, industry cumulative and syndicated reports 521 include aggregate assessment responses measures 523, top performer lists 525, bottom performer lists 527, outliers 529, and trend reporting 531. In particular embodiments, tracking and reporting includes specific products, categories, companies, brands.

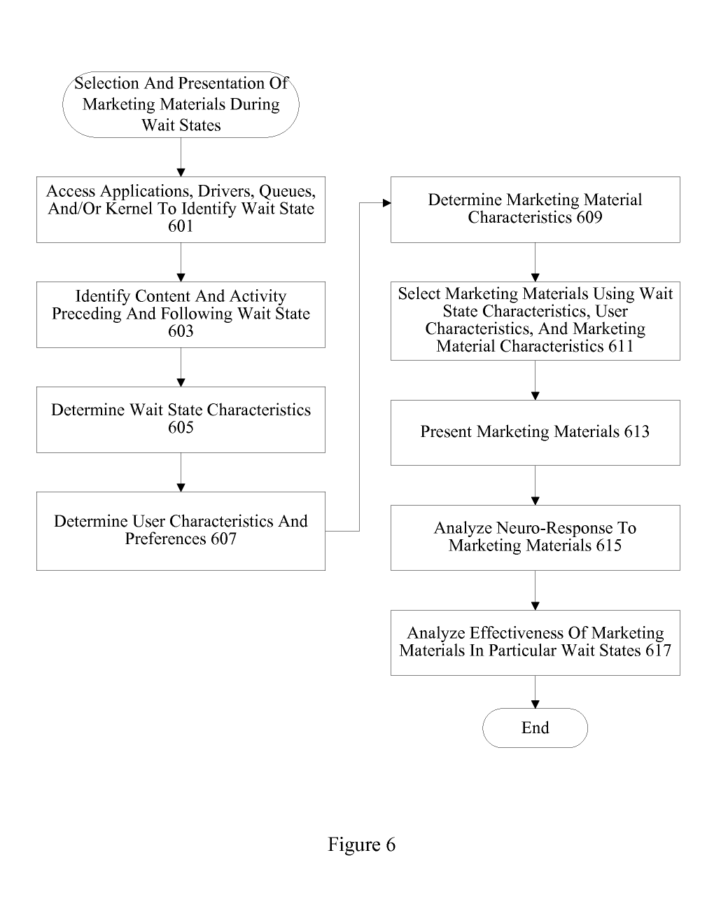

FIG. 6 illustrates one example of a technique for selecting and presenting marketing materials during wait states. According to various embodiments, applications, drivers, queues, and/or the kernel itself is accessed to identify any pending wait state at 601. Monitoring applications, drivers, queues, hardware components, and/or the kernel itself is referred to herein as platform monitoring. Various wait states can be detected with a platform monitor versus an application monitor which may be integrated within an application but only detect wait states associated with that particular application. When an application makes a request that may take time to complete, a wait state marketing material presentation mechanism may be triggered to select and present marketing materials. In some examples, an application itself may request presentation of marketing materials. However, in many instances, a wait state presentation system is not integrated with a particular application but may reside on an operating system or may be a platform monitor. The wait state presentation system monitors drivers, queues, and/or the kernel itself to identify potential wait states. In some instances, the wait state presentation system is triggered by identifying a pending download of a large file or a request for a particular processor or storage intensive operation.

According to various embodiments, the wait state presentation system then identifies content and activity preceding and following a wait state at 603. In many instances, this data may not be known. However, in some instances, it may be detected that a user was running a particular application prior to requesting download of a selected type of content. The application and the content may prime or be primed respectively by the wait state marketing materials. For example, an application relating to a restaurant finder may prime marketing materials associated with dining out or food. Marketing materials relating to computers may prime content related to computer instructional materials. At 605, wait state characteristics are determined. Wait state characteristics may include priming data, as well as wait state length, processor availability, network bandwidth availability, etc. At 607, user characteristics and preferences may be determined. User characteristics and preferences may include profile information, demographic information, interests, activities, past purchases, etc. Marketing materials characteristics at 609 may be determined to allow selection and matching of marketing materials with wait state slots. In some examples, marketing materials are selected using wait state characteristics, user characteristics, and marketing material characteristics at 611 to identify marketing materials most appropriate for particular slots.

At 613, marketing materials are presented to the user. According to various embodiments, neuro-response data including EEG data is collected and analyzed to determine user response to the marketing materials presented during the wait state at 615. At 617, the effectiveness of marketing materials in particular wait states is analyzed. This data can be used to improve marketing material characteristic information to further enhance the selection process.

A variety of mechanisms can be used to perform data analysis. In particular embodiments, a stimulus attributes repository is accessed to obtain attributes and characteristics of the stimulus materials, along with purposes, intents, objectives, etc. In particular embodiments, EEG response data is synthesized to provide an enhanced assessment of effectiveness. According to various embodiments, EEG measures electrical activity resulting from thousands of simultaneous neural processes associated with different portions of the brain. EEG data can be classified in various bands. According to various embodiments, brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus.

Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making Gamma waves occur between 30 and 60 Hz and are involved in binding of different populations of neurons together into a network for the purpose of carrying out a certain cognitive or motor function, as well as in attention and memory. Because the skull and dermal layers attenuate waves in this frequency range, brain waves above 75-80 Hz are difficult to detect and are often not used for stimuli response assessment.

However, the techniques and mechanisms of the present invention recognize that analyzing high gamma band (kappa-band: Above 60 Hz) measurements, in addition to theta, alpha, beta, and low gamma band measurements, enhances neurological attention, emotional engagement and retention component estimates. In particular embodiments, EEG measurements including difficult to detect high gamma or kappa band measurements are obtained, enhanced, and evaluated. Subject and task specific signature sub-bands in the theta, alpha, beta, gamma and kappa bands are identified to provide enhanced response estimates. According to various embodiments, high gamma waves (kappa-band) above 80 Hz (typically detectable with sub-cranial EEG and/or magnetoencephalography) can be used in inverse model-based enhancement of the frequency responses to the stimuli.

Various embodiments of the present invention recognize that particular sub-bands within each frequency range have particular prominence during certain activities. A subset of the frequencies in a particular band is referred to herein as a sub-band. For example, a sub-band may include the 40-45 Hz range within the gamma band. In particular embodiments, multiple sub-bands within the different bands are selected while remaining frequencies are band pass filtered. In particular embodiments, multiple sub-band responses may be enhanced, while the remaining frequency responses may be attenuated.

An information theory based band-weighting model is used for adaptive extraction of selective dataset specific, subject specific, task specific bands to enhance the effectiveness measure. Adaptive extraction may be performed using fuzzy scaling. Stimuli can be presented and enhanced measurements determined multiple times to determine the variation profiles across multiple presentations. Determining various profiles provides an enhanced assessment of the primary responses as well as the longevity (wear-out) of the marketing and entertainment stimuli. The synchronous response of multiple individuals to stimuli presented in concert is measured to determine an enhanced across subject synchrony measure of effectiveness. According to various embodiments, the synchronous response may be determined for multiple subjects residing in separate locations or for multiple subjects residing in the same location.

Although a variety of synthesis mechanisms are described, it should be recognized that any number of mechanisms can be applied—in sequence or in parallel with or without interaction between the mechanisms.

Although intra-modality synthesis mechanisms provide enhanced significance data, additional cross-modality synthesis mechanisms can also be applied. A variety of mechanisms such as EEG, eye tracking, FMRI, EOG, and facial emotion encoding are connected to a cross-modality synthesis mechanism. Other mechanisms as well as variations and enhancements on existing mechanisms may also be included. According to various embodiments, data from a specific modality can be enhanced using data from one or more other modalities. In particular embodiments, EEG typically makes frequency measurements in different bands like alpha, beta and gamma to provide estimates of significance. However, the techniques of the present invention recognize that significance measures can be enhanced further using information from other modalities.

For example, facial emotion encoding measures can be used to enhance the valence of the EEG emotional engagement measure. EOG and eye tracking saccadic measures of object entities can be used to enhance the EEG estimates of significance including but not limited to attention, emotional engagement, and memory retention. According to various embodiments, a cross-modality synthesis mechanism performs time and phase shifting of data to allow data from different modalities to align. In some examples, it is recognized that an EEG response will often occur hundreds of milliseconds before a facial emotion measurement changes. Correlations can be drawn and time and phase shifts made on an individual as well as a group basis. In other examples, saccadic eye movements may be determined as occurring before and after particular EEG responses. According to various embodiments, time corrected FMRI measures are used to scale and enhance the EEG estimates of significance including attention, emotional engagement and memory retention measures.

Evidence of the occurrence or non-occurrence of specific time domain difference event-related potential components (like the DERP) in specific regions correlates with subject responsiveness to specific stimulus. According to various embodiments, ERP measures are enhanced using EEG time-frequency measures (ERPSP) in response to the presentation of the marketing and entertainment stimuli. Specific portions are extracted and isolated to identify ERP, DERP and ERPSP analyses to perform. In particular embodiments, an EEG frequency estimation of attention, emotion and memory retention (ERPSP) is used as a co-factor in enhancing the ERP, DERP and time-domain response analysis.

EOG measures saccades to determine the presence of attention to specific objects of stimulus. Eye tracking measures the subject's gaze path, location and dwell on specific objects of stimulus. According to various embodiments, EOG and eye tracking is enhanced by measuring the presence of lambda waves (a neurophysiological index of saccade effectiveness) in the ongoing EEG in the occipital and extra striate regions, triggered by the slope of saccade-onset to estimate the significance of the EOG and eye tracking measures. In particular embodiments, specific EEG signatures of activity such as slow potential shifts and measures of coherence in time-frequency responses at the Frontal Eye Field (FEF) regions that preceded saccade-onset are measured to enhance the effectiveness of the saccadic activity data.

According to various embodiments, facial emotion encoding uses templates generated by measuring facial muscle positions and movements of individuals expressing various emotions prior to the testing session. These individual specific facial emotion encoding templates are matched with the individual responses to identify subject emotional response. In particular embodiments, these facial emotion encoding measurements are enhanced by evaluating inter-hemispherical asymmetries in EEG responses in specific frequency bands and measuring frequency band interactions. The techniques of the present invention recognize that not only are particular frequency bands significant in EEG responses, but particular frequency bands used for communication between particular areas of the brain are significant. Consequently, these EEG responses enhance the EMG, graphic and video based facial emotion identification.

According to various embodiments, post-stimulus versus pre-stimulus differential measurements of ERP time domain components in multiple regions of the brain (DERP) are measured. The differential measures give a mechanism for eliciting responses attributable to the stimulus. For example the messaging response attributable to an advertisement or the brand response attributable to multiple brands is determined using pre-resonance and post-resonance estimates

Target versus distracter stimulus differential responses are determined for different regions of the brain (DERP). Event related time-frequency analysis of the differential response (DERPSPs) is used to assess the attention, emotion and memory retention measures across multiple frequency bands. According to various embodiments, the multiple frequency bands include theta, alpha, beta, gamma and high gamma or kappa. Priming levels and resonance for various products, services, and offerings are determined at different locations in the stimulus material. In some examples, priming levels and resonance are manually determined. In other examples, priming levels and resonance are automatically determined using neuro-response measurements. According to various embodiments, video streams are modified with different inserted advertisements for various products and services to determine the effectiveness of the inserted advertisements based on priming levels and resonance of the source material.

Multiple trials are performed to enhance priming and resonance measures. In particular embodiments, the priming and resonance measures are sent to a priming repository. The priming repository may be used to automatically select and place advertising suited for particular slots in a cluster. Advertisements may be automatically selected and arranged in advertisement slots to increase effectiveness.

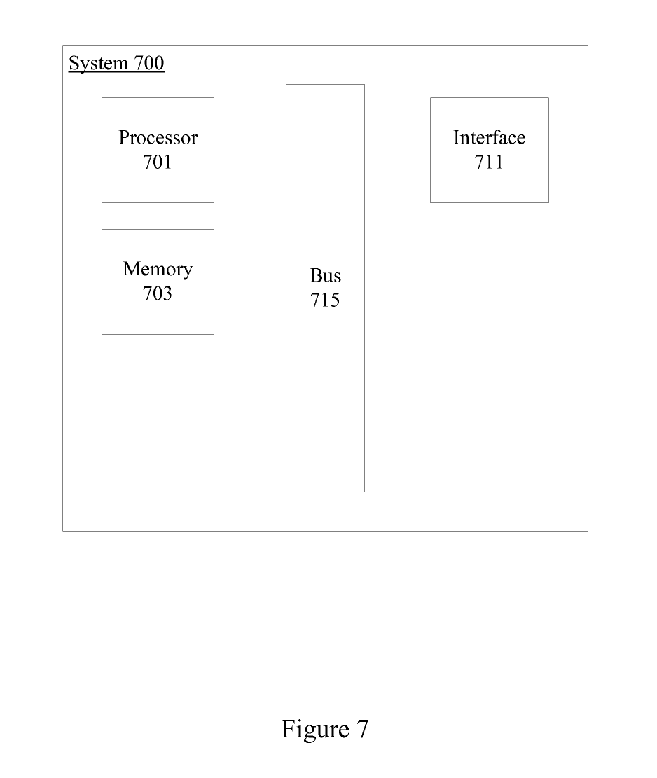

According to various embodiments, various mechanisms such as the data collection mechanisms, the intra-modality synthesis mechanisms, cross-modality synthesis mechanisms, etc. are implemented on multiple devices. However, it is also possible that the various mechanisms be implemented in hardware, firmware, and/or software in a single system. FIG. 7 provides one example of a system that can be used to implement one or more mechanisms.

According to particular example embodiments, a system 700 suitable for implementing particular embodiments of the present invention includes a processor 701, a memory 703, an interface 711, and a bus 715 (e.g., a PCI bus). When acting under the control of appropriate software or firmware, the processor 701 is responsible for tasks such as pattern generation. Various specially configured devices can also be used in place of a processor 701 or in addition to processor 701. The complete implementation can also be done in custom hardware. The interface 711 is typically configured to send and receive data packets or data segments over a network. Particular examples of interfaces the device supports include host bus adapter (HBA) interfaces, Ethernet interfaces, frame relay interfaces, cable interfaces, DSL interfaces, token ring interfaces, and the like.

According to particular example embodiments, the system 700 uses memory 703 to store data, algorithms and program instructions. The program instructions may control the operation of an operating system and/or one or more applications, for example. The memory or memories may also be configured to store received data and process received data.

Because such information and program instructions may be employed to implement the systems/methods described herein, the present invention relates to tangible, machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
monitoring a platform to detect a wait state corresponding to a device associated with a user, the device configured to run a plurality of applications;
determining wait state characteristics;
determining marketing material characteristics;
selecting marketing materials using marketing material characteristics and wait state characteristics; and
presenting the marketing materials to the user on the device during the wait state.

2. The method of claim 1, further comprising identifying content and/or activity preceding and following the wait state.

3. The method of claim 2, selecting marketing materials primed by content and/or activity preceding the wait state.

4. The method of claim 3, selecting marketing materials to prime the user for content and/or activity following the wait state.

5. The method of claim 1, further comprising determining user characteristics and preferences.

6. The method of claim 1, wherein marketing materials are selected using marketing material characteristics, wait state characteristics, and user characteristics and preferences.

7. The method of claim 1, further comprising obtaining neuro-response data from the user exposed to the marketing materials.

8. The method of claim 7, wherein neuro-response data comprises electroencephalography (EEG) data.

9. The method of claim 8, wherein neuro-response data is analyzed to determine memory retention, emotional engagement, and attention levels.

10. The method of claim 9, wherein neuro-response data is analyzed by obtaining target and distracter event related potential (ERP) measurements to determine differential measurements of ERP time domain components at multiple regions of the brain (DERP).

11. The method of claim 10, wherein neuro-response data is further analyzed by obtaining event related time-frequency analysis of a differential response to assess the attention, emotion and memory retention (DERPSPs) across multiple frequency bands.
